(19) United States
(12) Patent Application Publication
(10) Pub. No.: US 2006/0009164 A1
(43) Pub. Date: Jan. 12, 2006

(54) Radio frequency switching circuit

(75) Inventor: Shigeru Kataoka, Kawasaki-shi (JP)

Correspondence Address: STEPTOE & JOHNSON LLP, 1330 CONNECTICUT AVENUE, N.W., WASHINGTON, DC, 20036, US

(73) Assignee: MATSUSHITA ELECTRIC INDUSTRIAL CO., LTD., Osaka (JP)

(21) Appl. No.: 11/152,242

(22) Filed: Jun. 15, 2005

(30) Foreign Application Priority Data
Jul. 7, 2004 (JP) 2004-199950

(51) Int. Cl. H04B 1/44

(52) U.S. Cl. 455/83; 455/78

(57) ABSTRACT

By using the leakage of an RF signal, transmitted power is controlled without using a signal distributor such as a directional coupler. The RF signal is leaked due to a parasitic capacitance between the source (or drain) terminal and the gate terminal of an FET constituting a transmission-side FET switching circuit of an RF switching circuit.

### FIELD OF THE INVENTION

The present invention relates to a wireless installation such as a mobile communication apparatus and particularly to a radio frequency switching circuit for switching transmission and reception.

### BACKGROUND OF THE INVENTION

In recent years, radio frequency switching circuits (hereinafter, referred to as RF switching circuits) constituted of field-effect transistors (hereinafter, referred to as FETs) have been put into practical use. Such radio frequency switching circuits have a small size and low power consumption with an excellent radio frequency characteristic. Further, radio frequency amplifiers constituted of FETs and heterojunction bipolar transistors (hereinafter, referred to as HBTs) have been put into practical use. Such radio frequency amplifiers have high efficiency and an excellent low-voltage operation characteristic.

Against the backdrop of rapid development in the field of semiconductor technology, smaller and lighter portable radio terminals have grown in demand. Attempts are being made to integrate an overall main transmitter circuit including a radio frequency amplifier (hereinafter, referring to as an RF amplifier) and an RF switching circuit.

In an RF amplifier, the level of transmitted power is generally controlled by comparing a reference voltage and the level of a signal having branched from transmitted output.

As shown in FIG. 13, as a unit for branching a part of a transmitted signal from transmitted output, a directional coupler 3 for detecting a transmitted signal is connected between the output of an RF amplifier 2 and an RF switching circuit 11 interposed between the RF amplifier 2 and an antenna-side input/output terminal 8.

Reference numeral 1 denotes a transmitted signal input terminal, reference numeral 4 denotes a gain control circuit, reference numeral 5 denotes a reference voltage input terminal, reference numeral 6 denotes a detector circuit, reference numeral 7 denotes a terminating resistor, reference numerals 9a and 9b denote transmit/receive switching control terminals, reference numeral 10 denotes a received signal output terminal, reference numeral 12 denotes a DC signal component cut-off element, reference numeral 13 denotes a transmission-side through FET switching circuit, reference numeral 14 denotes a transmission-side shunt FET switching circuit, reference numeral 15 denotes a reception-side through FET switching circuit, reference numeral 16 denotes a reception-side shunt FET switching circuit, and reference numeral 17 denotes control terminal protection elements.

An SPDT RF switching circuit generally used for a cellular phone or the like is illustrated as an example of the RF switching circuit 11. The function of the SPDT (single pole double throw) RF switching circuit is specifically described in a document such as Japanese Patent Laid-Open No. 2003-298430 and thus the explanation thereof is omitted in the present specification.

First, a functional operation upon transmission will be discussed below.

A radio frequency transmitted signal is inputted to the transmitted signal input terminal 1 and amplified by the RF amplifier 2. The amplified radio frequency transmitted signal is inputted to the transmission-side input terminal of the RF switching circuit 11 through the directional coupler 3 and the DC signal component cut-off element 12.

Apart of the amplified radio frequency transmitted signal is branched by the directional coupler 3 and outputted to the detector circuit 6. The detector circuit 6 detects the branched transmitted signal and outputs, to the gain control circuit 4, a detection voltage signal corresponding to the level of the branched transmitted signal.

Therefore, the voltage signal corresponding to the output level of the transmitted signal having been amplified by the RF amplifier 2 is supplied to the gain control circuit 4 because the directional coupler 3 has a certain degree of coupling. Further, the reference voltage input terminal 5 is fed with a reference voltage signal corresponding to a target level of the transmitted signal. The gain control circuit 4 compares the reference voltage signal and the detection voltage signal. When the detection voltage signal has a lower level than the reference voltage signal, the gain control circuit 4 controls the RF amplifier 2 so as to increase a gain. Conversely, when the detection voltage signal has a higher level than the reference voltage signal, the gain control circuit 4 controls the RF amplifier 2 so as to reduce a gain.

Thus, the transmitted signal of the RF amplifier 2 can be outputted as a transmitted signal of a target level.

In the RF switching circuit 11, upon transmission, an H level control signal is inputted to the transmit/receive switching control terminal 9a and an L level control signal is inputted to the transmit/receive switching control terminal 9b. Thus, the transmission-side through FET switching circuit 13 and the reception-side shunt FET switching circuit 16 are turned on and the transmission-side shunt FET switching circuit 14 and the reception-side through FET switching circuit 15 are turned off. The radio frequency transmitted signal is outputted from the antenna-side input/output terminal 8 through the transmission-side through FET switching circuit 13.

The power of the transmitted signal leaking to the gate terminals of FETs constituting the transmission-side FET switching circuit 13 and the transmission-side shunt FET switching circuit 14 is cut off in a radio frequency manner by the control terminal protection elements 17, so that the leakage of transmitted signal power to the gate terminal is minimized.

A functional operation upon reception will be discussed below.

Upon reception, an L level control signal is inputted to the transmit/receive switching control terminal 9a and an H level control signal is inputted to the transmit/receive switching control terminal 9b. The transmission-side through FET switching circuit 13 and the reception-side shunt FET switching circuit 16 are turned off and the transmission-side shunt FET switching circuit 14 and the reception-side through FET switching circuit 15 are turned on. A radio frequency received signal having been inputted to the antenna-side input/output terminal 8 is outputted from the received signal output terminal 10 through the reception-side through FET switching circuit 15.

However, the conventional art using the directional coupler 3 has the following problems:

1) Transmitted power has a passage loss due to the directional coupler 3 and the lost power has to be offset by an extra output of the RF amplifier for transmission, thereby increasing the current consumption of the RF amplifier for transmission.

2) When the function of the directional coupler 3 is formed on the substrate of a semiconductor integrated circuit together with the RF amplifier and the RF switching circuit, a long strip line is necessary on the substrate of the integrated circuit and occupies a large area, thereby increasing a chip size and cost.

3) Since the long strip line is present on the substrate of the integrated circuit, unnecessary electromagnetic coupling to other wires or elements appears, so that property degradation and abnormal oscillation may occur.

In this conventional art example, the SPDT RF switching circuit generally used for a cellular phone or the like was specifically described as an example. Even when other RF switching circuits are used, the generality of this problem is not lost.

An object of the present invention is to provide an RF switching circuit which can control transmitted output to a target level without the need for the dedicated directional coupler 3 when a main transmitter circuit including the RF amplifier 2 and the RF switching circuit 11 is entirely integrated, and is advantageous to miniaturization and low power consumption obtained by reducing a passage loss.

### DISCLOSURE OF THE INVENTION

The present invention provides an RF switching circuit which can eliminate the need for a directional coupler by using the power of a small transmitted signal leaking to the gate terminal of an FET constituting a transmission-side FET switching circuit, and is advantageous to miniaturization and low power consumption obtained by reducing a passage loss.

Particularly the most major characteristic is that the power of the small transmitted signal leaking to the gate terminal of the FET constituting the transmission-side FET switching circuit is separated from a transmit/receive switching control signal and outputted to a detector circuit.

An RF switching circuit according to a first aspect of the present invention comprises an FET switching circuit interposed between a first input fed with a radio frequency output from an RF amplifier and a first output for supplying the radio frequency output to the subsequent stage, the FET switching circuit being turned on/off in response to a switching signal, and a second output for feeding back, to the RF amplifier, a radio frequency signal (hereinafter, referred to as an RF signal) having leaked to the control terminal of the FET switching circuit.

According to a second aspect of the present invention, in the RF switching circuit of the first aspect, the FET switching circuit has a through FET switching circuit in which an output circuit has one end connected to the first input and the other end connected to the first output, and an RF signal having leaked to the control terminal of the through FET switching circuit is fed back to the RF amplifier.

According to a third aspect of the present invention, in the RF switching circuit of the first aspect, the FET switching circuit has a through FET switching circuit in which an output circuit has one end connected to the first input and the other end connected to the first output, and a shunt FET switching circuit having an output circuit connected between the first input and a reference voltage, and an RF signal having leaked to the control terminal of the through FET switching circuit is fed back to the RF amplifier.

According to a fourth aspect of the present invention, in the RF switching circuit according to the first aspect, the FET switching circuit has a through FET switching circuit of a multistage FET in which a plurality of FETs have source/drain terminals connected in series, the output circuit of the multistage FET has one end connected to the first input, the output circuit of the FET switching circuit has the other end connected to the first output, and an RF signal having leaked to at least one or more control terminals of the FET switching circuit is fed back to the RF amplifier.

According to a fifth aspect of the present invention, the RF switching circuit of the second aspect further comprises a coupling part interposed between the control terminal of the through FET switching circuit and the second output, the coupling part allowing only the passage of an RF signal component.

According to a sixth aspect of the present invention, the RF switching circuit of the third aspect further comprises a coupling part interposed between the control terminal of the through FET switching circuit and the second output, the coupling part allowing only the passage of an RF signal component.

According to a seventh aspect of the present invention, the RF switching circuit of the fourth aspect further comprises a coupling part interposed between the control terminal of the through FET switching circuit and the second output, the coupling part allowing only the passage of an RF signal component. a coupling part interposed between the control terminal of the through FET switching circuit and the second output, the coupling part allowing only the passage of an RF signal component.

An RF switching circuit according to an eighth aspect of the present invention comprises an FET switching circuit interposed between a first input fed with a radio frequency output from an RF amplifier and a first output for supplying the radio frequency output to the subsequent stage, the FET switching circuit being turned on/off in response to a switching signal, and a second output for feeding back, to the RF amplifier, an RF signal having leaked to the control terminal of the FET switching circuit, wherein the FET switching circuit comprises a through FET switching circuit including an output circuit having one end connected to the first input and the other end connected to the first output, and a shunt FET switching circuit including an output circuit connected between the first input and a reference voltage, wherein an RF signal having leaked to the control terminal of the shunt FET switching circuit is fed back to the RF amplifier.

An RF switching circuit according to a ninth aspect of the present invention comprises an FET switching circuit interposed between a first input fed with a radio frequency output from an RF amplifier and a first output for supplying the radio frequency output to the subsequent stage, the FET switching circuit being turned on/off in response to a switching signal, and a second output for feeding back, to the RF amplifier, an RF signal having leaked to the control terminal of the FET switching circuit, wherein the FET switching circuit comprises a through FET switching circuit including an output circuit having one end connected to the first input and the other end connected to the first output, and a shunt FET switching circuit including an output circuit connected between the first input and a reference voltage, and the shunt FET switching circuit comprises a multistage FET including a plurality of FETs having source/drain terminals connected in series, wherein an RF signal having leaked to the control terminal of the shunt FET switching circuit is fed back to the RF amplifier.

According to a tenth aspect of the present invention, the RF switching circuit of the second aspect further comprises a coupling part interposed between the control terminal of a shunt FET switching circuit and the second output, the coupling part allowing only the passage of an RF signal component.

According to an eleventh aspect of the present invention, the RF switching circuit of the third aspect further comprises a coupling part interposed between the control terminal of a shunt FET switching circuit and the second output, the coupling part allowing only the passage of an RF signal component.

According to a twelfth aspect of the present invention, the RF switching circuit of the fourth aspect further comprises a coupling part interposed between the control terminal of a shunt FET switching circuit and the second output, the coupling part allowing only the passage of an RF signal component.

According to a thirteenth aspect of the present invention, the RF switching circuit of any one of the fifth to seventh aspects further comprises a coupling part interposed between the control terminal of a shunt FET switching circuit and the second output, the coupling part allowing only the passage of an RF signal component.

According to a fourteenth aspect of the present invention, the RF switching circuit of the eighth aspect further comprises a coupling part interposed between the control terminal of the shunt FET switching circuit and the second output, the coupling part allowing only the passage of an RF signal component.

According to a fifteenth aspect of the present invention, the RF switching circuit of the ninth aspect further comprises a coupling part interposed between the control terminal of the shunt FET switching circuit and the second output, the coupling part allowing only the passage of an RF signal component.

With this configuration, by eliminating the need for a directional coupler, it is possible to eliminate a passage loss occurring on a transmitted signal due to the directional coupler, thereby reducing the power consumption of the RF amplifier. When a main transmitter circuit including the RF amplifier and the RF switching circuit is entirely formed on a semiconductor substrate, the circuit is simplified by eliminating the need for a directional coupler, thereby greatly reducing a chip size and cost. Further, since a long strip line is not necessary on an integrated semiconductor substrate, it is possible to eliminate unnecessary electromagnetic coupling to other wires or elements, thereby preventing degradation of property and abnormal oscillation.

### BRIEF DESCRIPTION OF THE DRAWINGS

FIG. 1 is a block diagram showing Embodiment 1 of the present invention;

FIG. 2 is a specific circuit diagram showing Embodiment 1 of the present invention;

FIGS. 3A to 3H are specific circuit diagrams each showing an FET switching circuit of Embodiment 1;

FIG. 4 is a block diagram showing Embodiment 2 of the present invention;

FIG. 5 is a specific circuit diagram showing Embodiment 2 of the present invention;

FIG. 6 is another block diagram showing Embodiment 3 of the present invention;

FIG. 7 is a circuit diagram showing (Example 1) of Embodiment 3;

FIG. 8 is a circuit diagram showing (Example 2) of Embodiment 3;

FIG. 9 is a circuit diagram showing (Example 3) of Embodiment 3;

FIG. 10 is a block diagram showing Embodiment 4 of the present invention;

FIG. 11 is a circuit diagram showing (Example 4) of Embodiment 4;

FIG. 12 is a circuit diagram showing (Example 5) of Embodiment 4; and

FIG. 13 is a specific circuit diagram showing a conventional art.

### DESCRIPTION OF THE EMBODIMENTS

Referring to FIGS. 1 to 12, the following will describe embodiments of the present invention.

### Embodiment 1

FIGS. 1 to 3 show Embodiment 1 of the present invention.

An RF switching circuit 11 shown in FIG. 1 comprises a transmission-side FET switching circuit 18, a reception-side FET switching circuit 19, an antenna-side input/output terminal 8, a received signal output terminal 10, transmit/receive switching control terminals 9a and 9b, control terminal protection elements 17, a DC signal component cut-off element 12, and a radio frequency signal passage element (hereinafter, referred to as an RF passage element) 20 serving as a coupling part allowing only the passage of a radio frequency signal component. A transmitted signal input terminal 1, an RF amplifier 2, a gain control circuit 4, a reference voltage input terminal 5, and a detector circuit 6 are provided in the previous stage of the RF switching circuit 11.

In the present embodiment, reference numeral IN1 denotes a first input where radio frequency output is inputted from the RF amplifier 2, reference numeral OUT 1 denotes a first output for supplying the radio frequency output to the subsequent stage, and reference numeral OUT2 denotes a second output for feeding back an RF signal to the RF amplifier 2.

First, a receiving operation will be discussed below.

Upon reception, control signals are supplied to the transmit/receive switching control terminals 9a and 9b in such a way that the transmission-side FET switching circuit 18 is turned off and the reception-side FET switching circuit 19 is turned on.

A transmitting operation will be discussed below.

A radio frequency transmitted signal is inputted to the transmitted signal input terminal 1 and amplified by the RF amplifier 2. The amplified radio frequency transmitted signal is inputted to the transmission-side FET switching circuit 18 of the RF switching circuit 11 through the DC signal component cut-off element 12.

A part of the radio frequency transmitted signal having been inputted to the RF switching circuit 11 leaks to the transmit/receive switching control terminal of the transmission-side FET switching circuit 18. The detector circuit 6 detects the leaked radio frequency transmitted signal through the RF passage element 20 and outputs, to the gain control circuit 4, a detection voltage signal corresponding to the level of the leaked radio frequency transmitted signal.

Therefore, the voltage signal corresponding to the output level of the transmitted signal having been amplified by the RF amplifier 2 is supplied to the gain control circuit 4.

Further, the reference voltage input terminal 5 is fed with a reference voltage signal corresponding to the level of the transmitted signal. The gain control circuit 4 compares the reference voltage signal and the detection voltage signal. When the detection voltage signal has a lower level than the reference voltage signal, the gain control circuit 4 controls the RF amplifier 2 so as to increase a gain. Conversely, when the detection voltage signal has a higher level than the reference voltage signal, the gain control circuit 4 controls the RF amplifier 2 so as to reduce a gain.

Thus, the transmitted signal of the RF amplifier 2 can be outputted as a transmitted signal of a target level.

The turning on/off of the transmission-side FET switching circuit 18 and the reception-side FET switching circuit 19 is switched by the transmit/receive switching control terminals 9a and 9b. In this case, an “on” state indicates that a signal is energized and an “off” state indicates that a signal is not energized.

Upon transmission, control signals are supplied to the transmit/receive switching control terminals 9a and 9b in such a way that the transmission-side FET switching circuit 18 is turned on and the reception-side FET switching circuit 19 is turned off. A radio frequency transmitted signal having been controlled to a predetermined level is outputted to the antenna-side input/output terminal 8 through the transmission-side FET switching circuit 18 but does not leak to the received signal output terminal 10.

The power of a transmitted signal leaking to the transmission-side FET switching circuit and the transmit/receive switching control terminal of the transmission-side FET switching circuit is cut off in a radio frequency manner by the control terminal protection element 17, so that leakage to the outside of the RF switching circuit 11 is minimized.

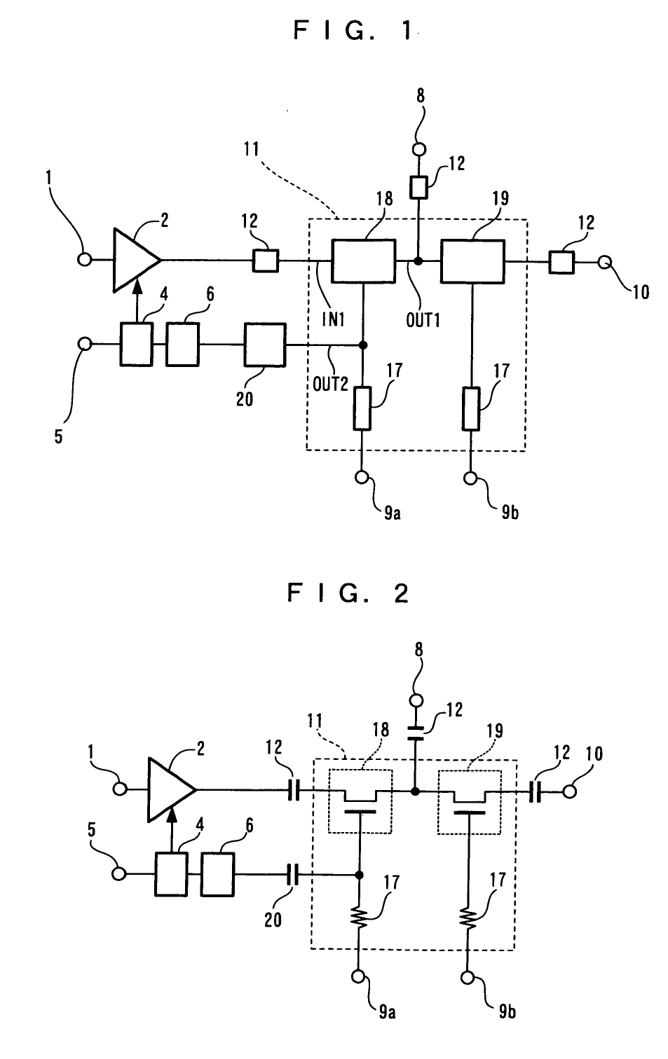

FIG. 2 is a specific circuit diagram of FIG. 1.

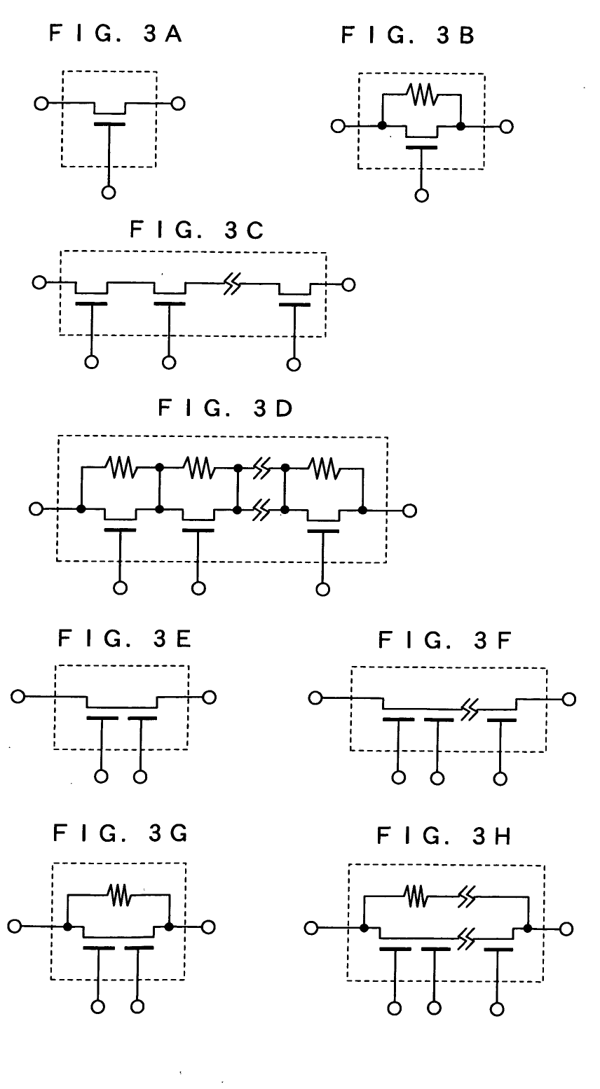

In the RF switching circuit shown in FIG. 2, an FET of FIG. 3A constitutes the transmission-side FET switching circuit 18 and reception-side FET switching circuit 19 shown in FIG. 1, a resistor constitutes the control terminal protection element 17, a capacitor constitutes the DC signal component cut-off element 12, and a capacitor constitutes the RF signal passage element 20.

The transmission-side FET switching circuit 18 and the reception-side FET switching circuit 19 are not limited to the FET switching circuit of FIG. 3A and may be constituted of any combinations of FET switching circuits shown in FIGS. 3A to 3H.

The control terminal protection element 17 is not limited to a resistor. Other elements or circuits are applicable as long as the elements or circuits cut off an RF signal component and allows the passage of a DC signal component.

Moreover, the DC signal component cut-off element 12 and the RF signal passage element 20 are not limited to capacitors. Other elements or circuits are applicable as long as the elements or circuits allow the passage of an RF signal component and cut off a DC signal component.

The DC signal component cut-off element 12 and the RF signal passage element 20 may be entirely or partly integrated into the RF switching circuit.

First, a receiving operation will be discussed below.

Upon reception, an L level signal is supplied as a control signal to the transmit/receive switching control terminal 9a and an H level signal is supplied as a control signal to the transmit/receive switching control terminal 9b. Then, the transmission-side FET switching circuit 18 is turned off and the reception-side FET switching circuit 19 is turned on. A radio frequency received signal, which has been received by an antenna, is outputted to the received signal output terminal 10 through the RF switching circuit 11.

Then, a transmitting operation will be discussed below.

A radio frequency transmitted signal is inputted to the transmitted signal input terminal 1 and amplified by the RF amplifier 2 for transmission. The amplified radio frequency transmitted signal is inputted to the transmission-side FET switching circuit 18 of the RF switching circuit 11 through the DC signal component cut-off element 12.

In the FET constituting the transmission-side FET switching circuit 18, a part of radio frequency transmitted signal leaks to the gate terminal due to the presence of a capacitance between the source (or drain) and the gate. The resistor (the control terminal protection element 17) and the capacitor (the RF passage element 20) are connected to the gate terminal and the leaked radio frequency transmitted signal is inputted to the detector circuit 6 through the capacitor (the RF passage element 20). A signal quantity inputted to the detector circuit 6 can be adjusted by a capacitance value of the capacitor (the RF passage element 20).

The detector circuit 6 detects the leaked radio frequency transmitted signal through the capacitor (the RF passage element 20) and outputs, to the gain control circuit 4, a detection voltage signal corresponding to the level of the leaked radio frequency transmitted signal. Therefore, the voltage signal corresponding to the output level of the transmitted signal having been amplified by the RF amplifier 2 for transmission is supplied to the gain control circuit 4.

Further, the reference voltage input terminal 5 is fed with a reference voltage signal corresponding to the level of the transmitted signal. The gain control circuit 4 compares the reference voltage signal and the detection voltage signal. When the detection voltage signal has a lower level than the reference voltage signal, the gain control circuit 4 controls the RF amplifier 2 so as to increase a gain. Conversely, when the detection voltage signal has a higher level than the reference voltage signal, the gain control circuit 4 controls the RF amplifier 2 so as to reduce a gain.

Thus, the transmitted signal of the RF amplifier 2 can be outputted as a transmitted signal of a target level.

Upon transmission, an H level signal is supplied to the transmit/receive switching control terminal 9a and the transmission-side FET switching circuit 18 is turned on via the resistor (the control terminal protection element 17). The capacitor (the RF passage element 20) is connected between the detector circuit 6 and the gate terminal of the FET constituting the transmission-side FET switching circuit 18, so that a DC signal component does not leak and the detector circuit 6 is not affected.

On the other hand, an L level signal is supplied as a control signal to the transmit/receive switching control terminal 9b and the reception-side FET switching circuit 19 is turned off. The radio frequency transmitted signal having been amplified by the RF amplifier 2 for transmission is outputted to the antenna-side input/output terminal 8 through the RF switching circuit 11 and radiated through the antenna.

In this way, it is possible to achieve the RF switching circuit which can eliminate the need for a directional coupler and is advantageous to miniaturization and low power consumption obtained by reducing a passage loss.

### Embodiment 2

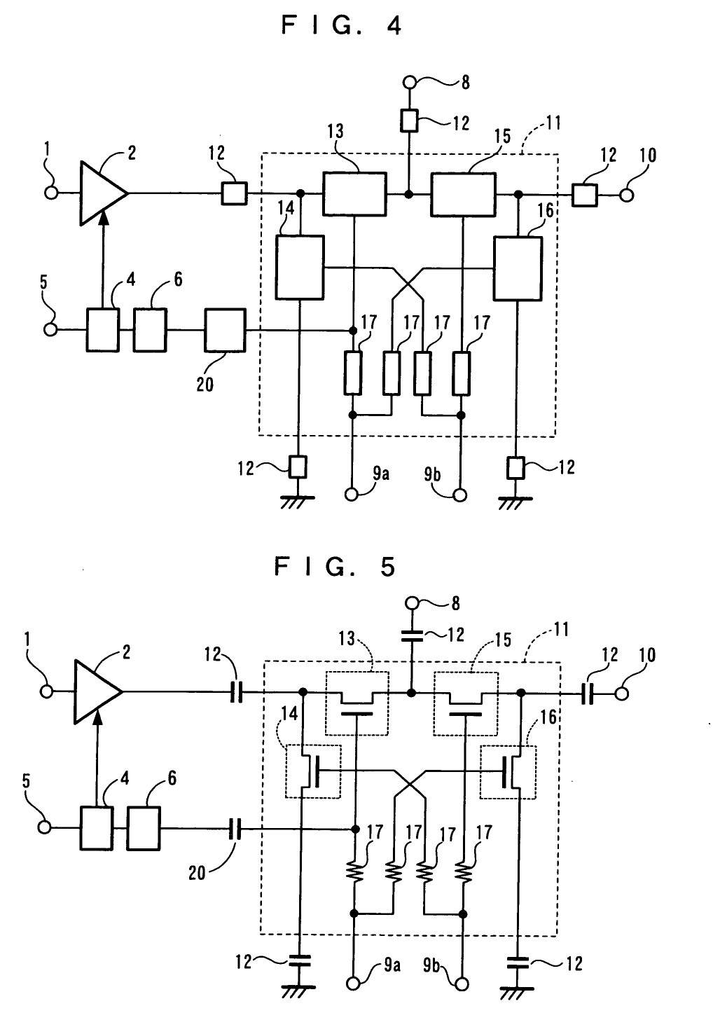

FIGS. 4 and 5 show Embodiment 2 of the present invention.

In FIGS. 1 and 2, only the transmission-side FET switching circuit 18 constitutes an FET switching circuit interposed between the first input fed with radio frequency output from the RF amplifier 2 and the antenna-side input/output terminal 8 for supplying radio frequency output to the subsequent stage of the radio frequency output. In Embodiment 2, as shown in FIG. 4, an FET switching circuit is constituted of a transmission-side through FET circuit 13 and a transmission-side shunt FET circuit 14.

The reception-side FET switching circuit 19 of FIGS. 1 and 2 is equivalent to a so-called SPDT RF switching circuit constituted of a reception-side through FET switching circuit 15 and a reception-side shunt FET switching circuit 16. In the RF switching circuit, a radio frequency transmitted signal leaking to the transmit/receive switching terminal of the transmission-side through FET circuit 13 is outputted to a detector circuit 6 through an RF passage element 20 connected to the transmit/receive switching control terminal.

One end of the transmission-side shunt FET circuit 14 and one end of the reception-side shunt FET switching circuit 16 are connected to a reference voltage via DC signal component cut-off elements 12 each of which is constituted of a capacitor.

FIG. 5 shows a specific circuit.

An RF switching circuit 11 of FIG. 5 is an example where the specific FET switching circuit of FIG. 3A is used as the transmission-side through FET circuit 13, the transmission-side shunt FET circuit 14, the reception-side through FET switching circuit 15, and the reception-side shunt FET switching circuit 16 of FIG. 4. A control terminal protection element 17 is a resistor, and the DC signal component cut-off element 12 and the RF passage element 20 are capacitors.

The FET switching circuit is not limited to the FET switching circuit of FIG. 3A and may be constituted of any combinations of FET switching circuits shown in FIGS. 3A to 3H.

The control terminal protection element 17 is not limited to a resistor. Other elements or circuits are applicable as long as the elements or circuits cut off an RF signal component and allows the passage of a DC signal component.

Moreover, the DC signal component cut-off element 12 and the RF signal passage element 20 are not limited to capacitors. Other elements or circuits are applicable as long as the elements or circuits allow the passage of an RF signal component and cut off a DC signal component.

The DC signal component cut-off element 12 and the RF passage element 20 may be entirely or partly integrated into the RF switching circuit.

In the SPDT RF switching circuit, the gain of the RF amplifier 2 for transmission is controlled by using the leakage of a part of a radio frequency transmitted signal having been inputted to the RF switching circuit 11. The radio frequency transmitted signal leaks to the gate terminal due to a capacitance between the source (or drain) and the gate of the FET constituting the transmission-side through FET circuit 13.

In Embodiment 2, the SPDT RF switching circuit generally used for a cellular phone or the like was specifically described as an example. Even when a radio frequency integrated circuit is constituted of other RF switching circuits, the generality of the present invention is not lost.

### Embodiment 3

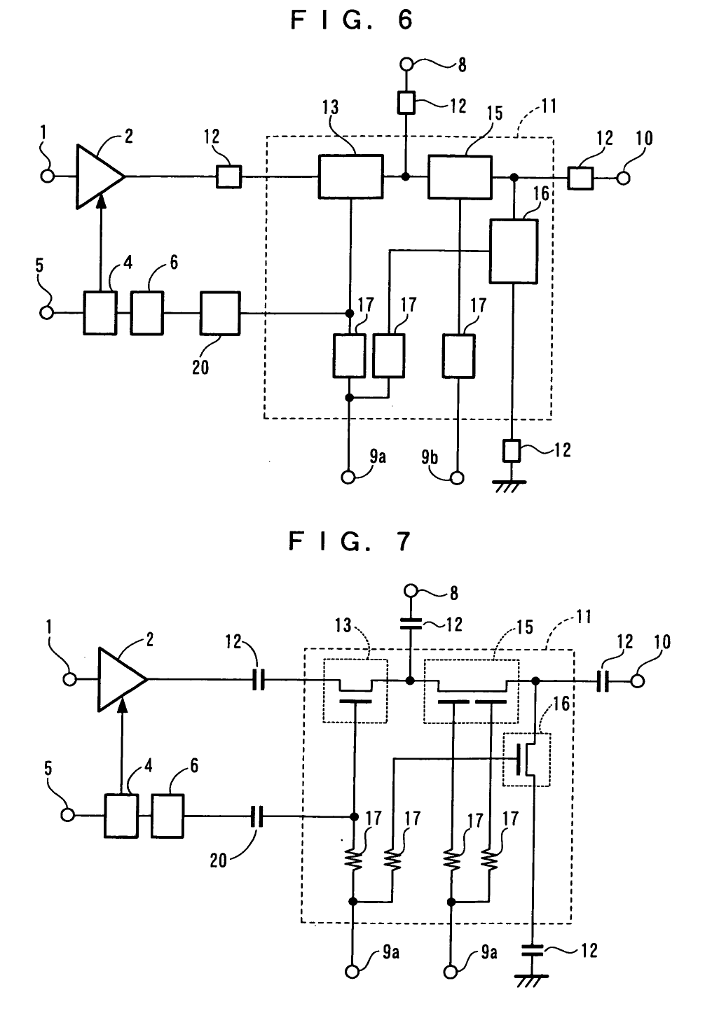

FIGS. 6 to 9 show Embodiment 3 of the present invention.

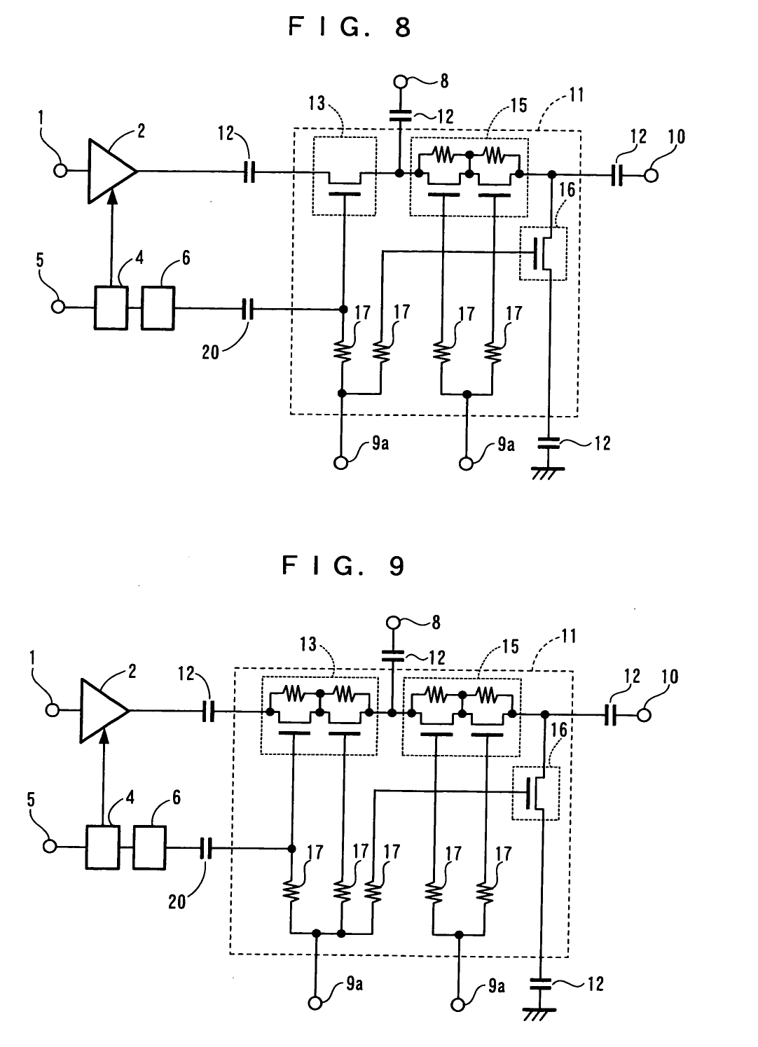

In FIG. 4, the main part of the RF switching circuit 11 is constituted of the transmission-side through FET circuit 13 and transmission-side shunt FET circuit 14 and the reception-side through FET circuit 15 and reception-side shunt FET circuit 16. In an RF switching circuit shown in FIG. 6, a transmission-side shunt FET circuit 14 is not absent and a reception-side through FET circuit 15 is constituted of a multistage FET where the source/drain terminals of two or more FETs are connected in series as shown in FIGS. 7 and 8.

### EXAMPLE 1

In FIG. 7, the transmission-side shunt FET switching circuit 14 of FIG. 4 is omitted and a reception-side through FET switching circuit 15 is constituted of a specific FET switching circuit shown in FIG. 3E. RF signal having leaked to the control terminal of a transmission-side through FET circuit 13 is supplied through an RF signal passage element 20, a detector circuit 6, and a gain control circuit 4 to a feedback circuit to an RF amplifier circuit 2. In this respect, (Example 1) is similar to (Example 2) and (Example 3) below.

A transmitted output is not sufficiently attenuated because the transmission-side shunt FET switching circuit 14 is omitted but the transmitted output is sufficiently attenuated by the multistage FET of the reception-side through FET switching circuit 15, so that the output is not generated on the received signal output terminal 10.

### EXAMPLE 2

In FIG. 8, the transmission-side shunt FET switching circuit 14 of FIG. 4 is omitted and a reception-side through FET switching circuit 15 is constituted of a specific FET switching circuit shown in FIG. 3D. The operation thereof is similar to that of (Example 1).

### EXAMPLE 3

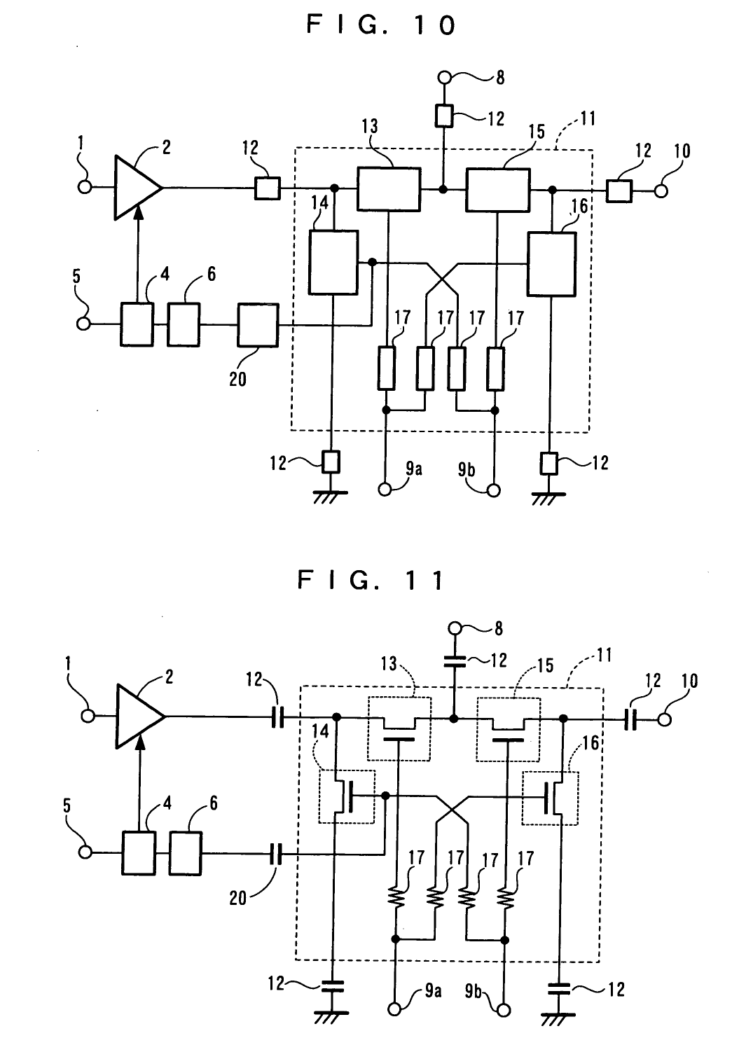

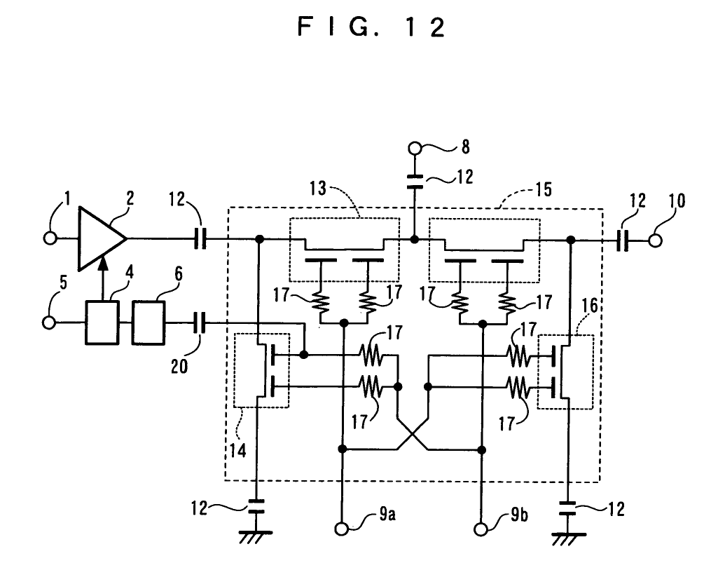

In FIG. 9, the transmission-side shunt FET switching circuit 14 of FIG. 4 is omitted, and a transmission-side through FET switching circuit 13 and a reception-side through FET switching circuit 15 are each constituted of a specific FET switching circuit shown in FIG. 3D. The operation thereof is similar to that of (Example 1).

### Embodiment 4

FIGS. 10, 11, and 12 show Embodiment 4 of the present invention.

In the foregoing embodiments, an RF signal having leaked to the control terminal of the transmission-side through FET switching circuit 13 is supplied to the detector circuit 6 through the RF signal passage element 20 to control the transmission power level of the RF amplifier 2. Embodiment 4 is different only in that an RF signal having leaked to the control terminal of a transmission-side shunt FET switching circuit 14 is fed back to control the transmission power level of an RF amplifier 2 as shown in FIG. 10.

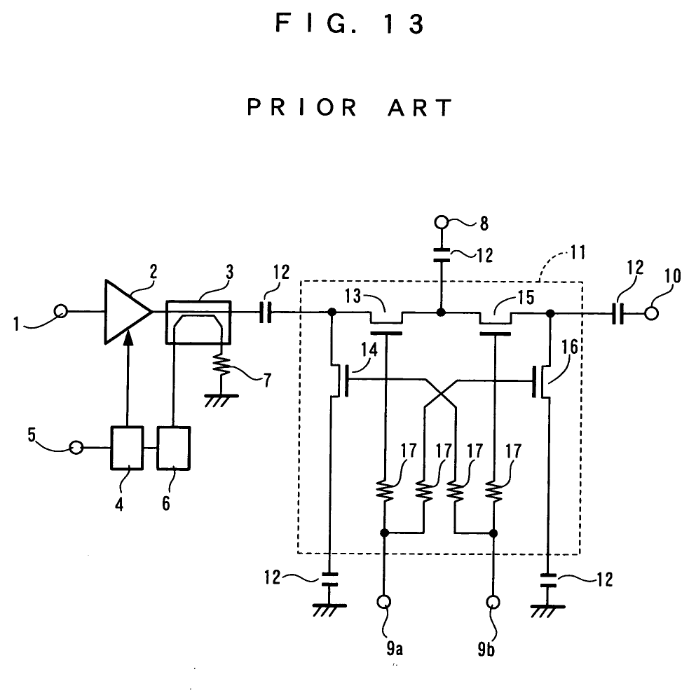

(Example 4) in FIG. 11 shows a specific circuit. In FIG. 11, a transmission-side through FET circuit 13, a transmission-side shunt FET circuit 14, a reception-side through FET circuit 15, and a reception-side shunt FET circuit 16 are each constituted of an FET shown in FIG. 3A. (Example 5) shown in FIG. 12 is different only in that a transmission-side through FET circuit 13, a transmission-side shunt FET circuit 14, a reception-side through FET circuit 15, and a reception-side shunt FET circuit 16 are each constituted of a multistage FET shown in FIG. 3E. The structure of the used multistage FET is not limited to FIG. 3E. Any one of FIGS. 3C, 3D, 3F, 3G, and 3H can be used. Further, the multistage FET may be constituted of any combinations of the FET switching circuits shown in FIGS. 3A to 3H.

A control terminal protection element 17 is not limited to a resistor. Other elements or circuits are applicable as long as the elements or circuits cut off an RF signal component and allows the passage of a DC signal component. Moreover, a DC signal component cut-off element 12 and an RF signal passage element 20 are not limited to capacitors. Other elements or circuits are applicable as long as the elements or circuits allow the passage of an RF signal component and cut off a DC signal component.

The DC signal component cut-off element 12 and the RF signal passage element 20 may be entirely or partly integrated into an RF switching circuit.

In an SPDT RF switching circuit, the gain of the RF amplifier 2 is controlled by using the leakage of a part of a radio frequency transmitted signal having been inputted to the RF switching circuit 11. The radio frequency transmitted signal leaks to the gate terminal due to a capacitance between the source (or drain) and the gate of an FET constituting the transmission-side shunt FET circuit 14.

The foregoing RF switching circuits can contribute to an integrated circuit of a wireless installation such as a mobile communication apparatus. Since a long strip line is not necessary on an integrated semiconductor substrate, it is possible to eliminate unnecessary electromagnetic coupling to other wires or elements, thereby preventing degradation of property and abnormal oscillation.

1. A radio frequency switching circuit, comprising:
an FET switching circuit interposed between a first input fed with a radio frequency output from a radio frequency amplifier and a first output for supplying the radio frequency output to a subsequent stage, the FET switching circuit being turned on/off in response to a switching signal, and
a second output for feeding back, to the radio frequency amplifier, a radio frequency signal having leaked to a control terminal of the FET switching circuit.

2. The radio frequency switching circuit according to claim 1, wherein
the FET switching circuit comprises a through FET switching circuit including an output circuit having one end connected to the first input and the other end connected to the first output, wherein a radio frequency signal having leaked to a control terminal of the through FET switching circuit is fed back to the radio frequency amplifier.

3. The radio frequency switching circuit according to claim 1, wherein
the FET switching circuit comprises a through FET switching circuit including an output circuit having one end connected to the first input and the other end connected to the first output, and a shunt FET switching circuit having an output circuit connected between the first input and a reference voltage, wherein a radio frequency signal having leaked to a control terminal of the through FET switching circuit is fed back to the radio frequency amplifier.

4. The radio frequency switching circuit according to claim 1, wherein
the FET switching circuit comprises a through FET switching circuit of a multistage FET comprising a plurality of FETs having source/drain terminals connected in series, the multistage FET including an output circuit having one end connected to the first input and the other end connected to the first output, wherein a radio frequency signal having leaked to at least one or more control terminals of the FET switching circuit is fed back to the radio frequency amplifier.

5. The radio frequency switching circuit according to claim 2, further comprising a coupling part interposed between the control terminal of the through FET switching circuit and the second output, the coupling part allowing only passage of a radio frequency signal component.

6. The radio frequency switching circuit according to claim 3, further comprising a coupling part interposed between the control terminal of the through FET switching circuit and the second output, the coupling part allowing only passage of a radio frequency signal component.

7. The radio frequency switching circuit according to claim 4, further comprising a coupling part interposed between the control terminal of the through FET switching circuit and the second output, the coupling part allowing only passage of a radio frequency signal component.

8. A radio frequency switching circuit, comprising:
an FET switching circuit interposed between a first input fed with a radio frequency output from a radio frequency amplifier and a first output for supplying the radio frequency output to a subsequent stage, the FET switching circuit being turned on/off in response to a switching signal, and
a second output for feeding back, to the radio frequency amplifier, a radio frequency signal having leaked to a control terminal of the FET switching circuit, wherein
the FET switching circuit comprises a through FET switching circuit including an output circuit having one end connected to the first input and the other end connected to the first output, and a shunt FET switching circuit including an output circuit connected between the first input and a reference voltage, wherein a radio frequency signal having leaked to a control terminal of the shunt FET switching circuit is fed back to the radio frequency amplifier.

9. A radio frequency switching circuit, comprising:
an FET switching circuit interposed between a first input fed with a radio frequency output from a radio frequency amplifier and a first output for supplying the radio frequency output to a subsequent stage, the FET switching circuit being turned on/off in response to a switching signal, and
a second output for feeding back, to the radio frequency amplifier, a radio frequency signal having leaked to a control terminal of the FET switching circuit, wherein
the FET switching circuit comprises a through FET switching circuit including an output circuit having one end connected to the first input and the other end connected to the first output, and a shunt FET switching circuit including an output circuit connected between the first input and a reference voltage, and
the shunt FET switching circuit comprises a multistage FET including a plurality of FETs having source/drain terminals connected in series, wherein a radio frequency signal having leaked to a control terminal of the shunt FET switching circuit is fed back to the radio frequency amplifier.

10. The radio frequency switching circuit according to claim 2, further comprising a coupling part interposed between a control terminal of a shunt FET switching circuit and the second output, the coupling part allowing only passage of a radio frequency signal component.

11. The radio frequency switching circuit according to claim 3, further comprising a coupling part interposed between a control terminal of a shunt FET switching circuit and the second output, the coupling part allowing only passage of a radio frequency signal component.

12. The radio frequency switching circuit according to claim 4, further comprising a coupling part interposed between a control terminal of a shunt FET switching circuit and the second output, the coupling part allowing only passage of a radio frequency signal component.

13. The radio frequency switching circuit according to claim 5, further comprising a coupling part interposed between a control terminal of a shunt FET switching circuit and the second output, the coupling part allowing only passage of a radio frequency signal component.

14. The radio frequency switching circuit according to claim 8, further comprising a coupling part interposed between the control terminal of the shunt FET switching circuit and the second output, the coupling part allowing only passage of a radio frequency signal component.

15. The radio frequency switching circuit according to claim 9, further comprising a coupling part interposed between the control terminal of the shunt FET switching circuit and the second output, the coupling part allowing only passage of a radio frequency signal component.
